(19) United States
(12) Patent Application Publication
(10) Pub. No.: US 2012/0057328 A1
(43) Pub. Date: Mar. 8, 2012

(54) Lighting Unit ( UFO )

(76) Inventor: Steven Neorcsik, Sydney (AU)

(21) Appl. No.: 13/319,345

(22) PCT Filed: May 31, 2010
(86) PCT No.: PCT/AU2010/000667

§ 371 Date: Nov. 8, 2011

(30) Foreign Application Priority Data
May 29, 2009 (AU) 2009902450

(51) Int. Cl. F21V 33/00

(52) U.S. Cl. 362/92

(57) ABSTRACT

There is disclosed a composite lighting unit 10 suitable for retro-fitting or for a DIY application, on the ceiling (14) of a room such as a bathroom. The unit includes a base (12) for mounting on the ceiling, an electric power connector (30) for connection to an existing light batten (16), light sockets (34) for holding light globes (38), sockets (42) for holding room heaters (44), and a fan (48) for dispersing steamy air in the room by directing the air across the ceiling. The unit also includes a deodoriser (64) for deodorising the room. The unit is adapted to be activated by a single electric switch (26) with the different components being actuated by selected switching actions on the switch.

### FIELD OF THE INVENTION

This invention relates to a lighting unit, in particular but not restricted to a retro-fit type, including lighting, a room heater, and a fan of a type used to disperse steamy air.

### BACKGROUND TO THE INVENTION

Ceiling-mounted, combined lighting, heating and fan units are known. These are usually used in bathroom or similar environments. They typically require an opening in the ceiling on which they are mounted, so that air, in particular steamy air, can be directed by the fan, through the opening, into the space above the ceiling to clear the steam from the room.

Such units are generally not of practical use in rooms where there is no space above the ceiling, or where there is no opening into such a ceiling space. Even in cases where there is a ceiling space, evacuating steamy air in this manner can be problematic as it can have undesirable consequences such as causing rotting of wooden structural components, mildew, and so on in the roof cavity unless it is ducted adding more time and cost.

In addition, because of the requirement for such an opening, and because of extra circuitry involved in the typical switching phase requiring separate switching for the light, fan and heaters forming part of such units, it is usually not easy to install them in existing rooms and run the extra required circuitry.

Indeed, the need for cutting such an opening is disadvantageous. It may also be necessary for a new electric circuit to be installed to accommodate the extra current needs typically drawn by some heaters forming part of such units It is usually not easy to install them in existing rooms given the presence of some heater components that require large current loads, if the existing circuit is merely suitable for normal lighting.

For this reason, such units are not particularly suitable for those wishing to install the units on a DIY (do it yourself) basis, and the services of a qualified electrician, and possible builder, will be required, incurring undesirable expense.

A further problem in this regard, is that, because of these installation requirements, such units are often not suitable or desirable in a scenario in which a person wishing to have the use of such a unit is renting the property in question. For example, such modifications to the premises might not be permitted, or it might be necessary for the person to reverse the modifications at the end of the rental period.

It is also very problematic in existing older high rise units that cannot vent into cavity ceiling roofs due to the construction nature of the building which does not allow for a cavity ceilings. Also existing first floor dwellings may be problematic especially in split level or underground structures that do not allow easy venting solutions.

A further problem with such existing Fan units is that, once they are installed, it is often not practicable to replace them if a replacement unit of similar dimensions is not available, and if the new unit may not properly conceal the existing ceiling opening.

A further problem exists, especially in but not restricted to the commercial colder northern hemisphere markets such as Europe and that is heating costs overall are significantly high as they have multiple bathrooms depending on the individual hotels/motels that are consuming energy unnecessarily for a good part of the year if not all year around (central heating) The only time heating of the bathroom should occur is when someone is actually using the bathroom and only the person should be heated not the air in the bathroom as this is unnecessarily and a waste of energy.

It is an object of the present invention to ameliorate one or more of the disadvantages of the prior art, or to provide a useful alternative.

### SUMMARY OF THE INVENTION

According to a first aspect of the invention, there is provided a composite lighting unit for the domestic and commercial markets including:

A base adapted to be mounted on a room ceiling;

Unit mounting means adapted for enabling mounting of the unit to the ceiling;

An electric power connector adapted for connection to a power source on the ceiling;

At least one light source on the Fan housing, adapted for an electrical connection between the globe and the electric power connector;

At least one heater connector supported on the base housing, adapted for connection to a room heater such that the unit can effect electrical connection between the heater and the electric power connector

At least one fan supported on the fan housing, wherein the unit is adapted to effect electrical connection between the fan and the electric power connector and adapted, when the unit is mounted to a said ceiling, to direct air blown by the fan, from below the fan and laterally with respect to the unit, across the surface of the ceiling.

In a preferred embodiment, the unit mounting means includes an aperture in the base, the aperture being adapted for receiving there through a light batten mounted on, and extending from, the ceiling.

Preferably the unit is adapted for the batten to extend downward through the aperture, and to be at least partly secured to the ceiling by a batten cap fixed to a free end of the batten below the aperture. Preferably the light batten constitutes a said power source by being connected to an electric power supply; the electric power connector being adapted for connection to the batten.

In a preferred embodiment, the power source forms part of an electric circuit which is adapted to be opened by a single switch.

Preferably the composite lighting unit both domestic and commercial variants includes circuitry for controlling supply of electric power from the electric power connector to components of the unit being the at least one light socket formation, the at least one heater connector, and the at least one fan, the circuitry being adapted such that different predetermined respective actions in relation to the circuitry cause an electrical connection to be effected between the electric power connector and—:

A predetermined respective one, or combination, of said components, wherein each said action includes a single instance of closing the circuit or a predetermined instance of successive closing and opening of the circuit within a predetermined time period for the domestic unit.

In a preferred embodiment the circuitry being adapted such that different predetermined respective actions in relation to the circuitry cause an electrical connection to be effected between the electric power connector and—:

one, or combination, of said components wherein each said action includes a single instance of closing the circuit or a predetermined instance of successive closing and opening of the circuit within a predetermined time period to determine winter and summer modes for the commercial unit and one, or combination, of said components thereafter controlling supply of electric power from the electric power connector to components of the unit.

In a preferred embodiment, the composite lighting unit includes at least one louvre for directing air forced by the fan upward and laterally with respect to the unit across the surface of the ceiling. In a preferred embodiment, the heater connector includes at least one socket for a heat lamp.

Preferably the composite lighting unit includes at least one infrared heat lamp and at least one socket for a heat lamp.

In a preferred embodiment, the composite lighting unit includes a deodorizer device mounted on the base, adapted for releasing a deodorizer substance.

Preferably the composite lighting unit includes a deodorizer device mounted on the base; the deodorizer device may be connected to the circuitry, and the circuitry being adapted to cause the deodorizer device to release a deodorizer substance.

### BRIEF DESCRIPTIONS OF THE DRAWINGS

Preferred embodiments of the invention will now be described, by way of example only, with reference to the accompanying drawings in which:

FIG. 1 is a schematic side view, shown partly cut away, of a lighting unit according to an embodiment of the invention including a diagrammatic view of an electric circuit for providing electric power to the unit of FIG. 1;

FIG. 2 is a schematic view from below of the lighting unit of FIG. 1;

FIG. 3 is a schematic end view of the lighting unit of FIG. 1 showing the heater globe and air louvers indicating air flow;

FIG. 4 is a schematic end view, showing a partly cut away of the lighting unit of FIG. 1 showing the two Led lights with the heat sinks attached.

### DETAILED DESCRIPTION

Referring to the drawings there is shown a lighting unit 1 according to an embodiment of the invention. The unit 1 has a base housing 27, preferably of plastics material, for mounting on the under-surface of a ceiling 3 of a room, typically a bathroom. According to the preferred embodiment, the base 27 is adapted to be mounted to an existing light batten 5 on the ceiling 3.

To enable this, the base housing 27 has a central aperture 4 through which the batten 5 can extend. The batten 5 is of a type having a threaded end (the threads not being shown) and a cap 6 for being screwed onto the batten.

The batten 5 is of a type suitable for serving as a socket for receiving light globes, and is therefore connected to an electric power supply 7 such as a mains supply to a home. The unit 1 is adapted for use with such a power supply 7 where the supply forms part of an electric/electronic circuit 8 which is adapted to be opened or closed by a single switch 9. The batten 5 has electric power contacts 10 which are suitable for engagement with mating contacts on a light globe. The power contacts 10 are connected to wiring 7 forming part of the electric circuit 8.

As the unit 1 is adapted to be electrically connected to the batten 5 in a similar fashion to such a light globe, it is provided with an electric power connector 12 which includes similar contacts 13 for connection to the contacts 10 in the batten 5

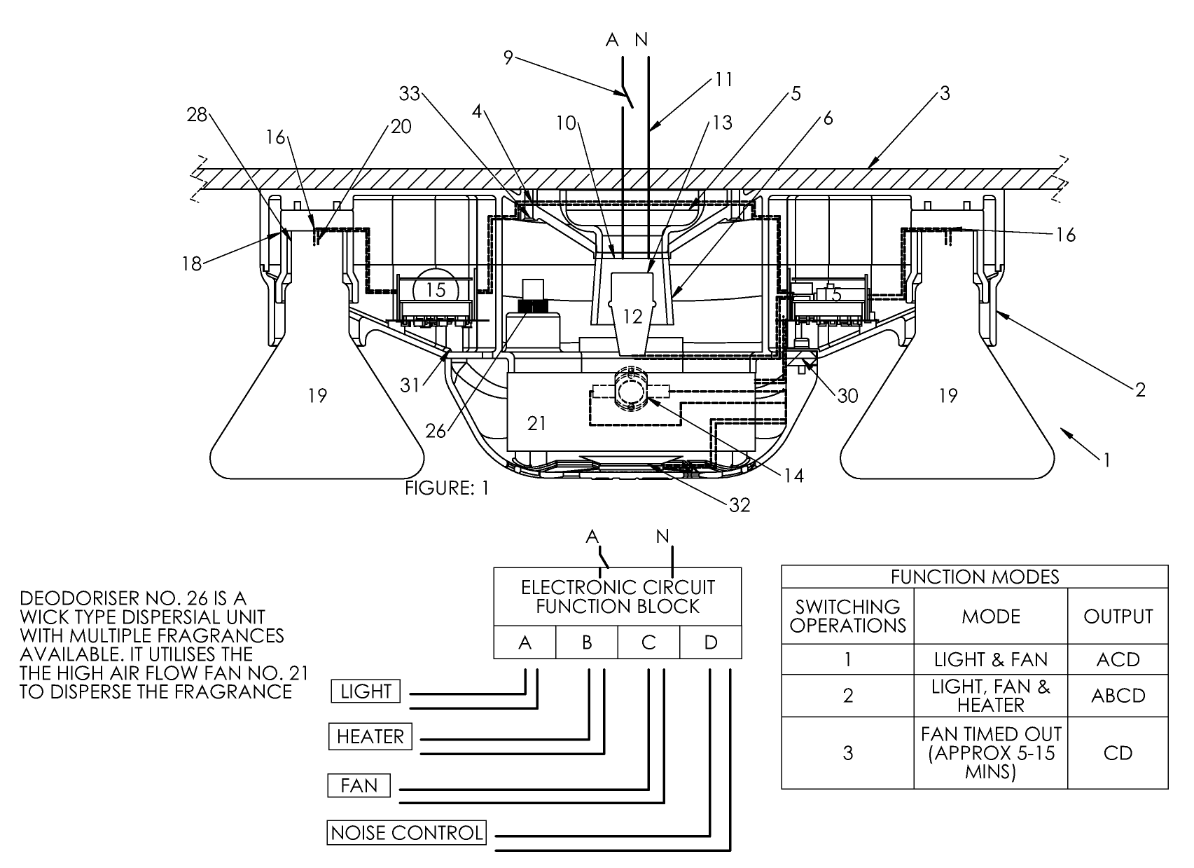

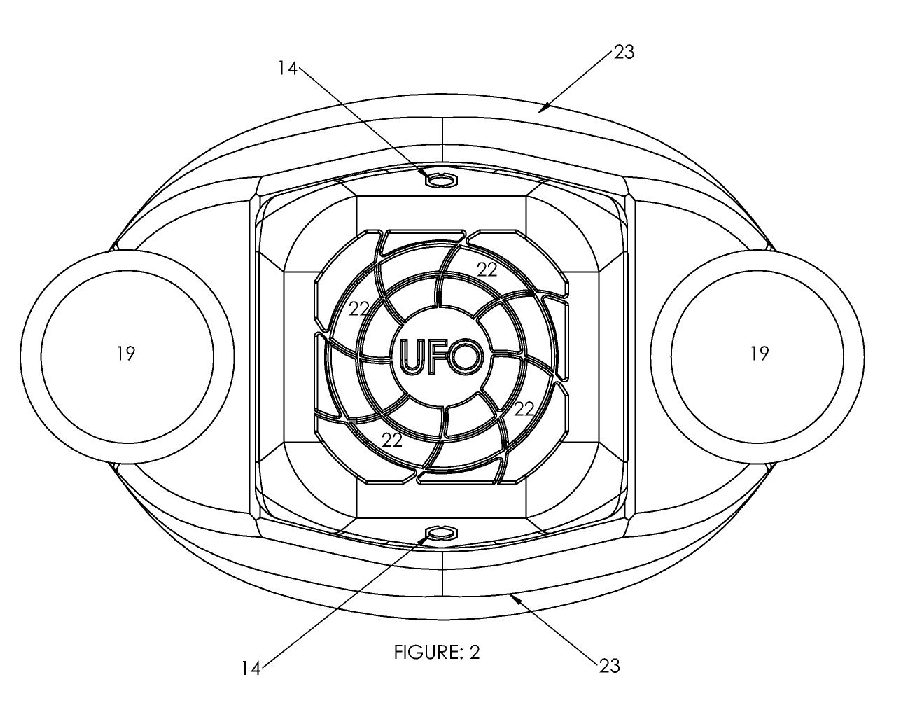

The unit 1 also has two light sources 14 is connected and controlled by the electronic circuitry 15, these connections being referenced 16 and shown in phantom lines in FIG. 1 supported within a fan housing 17.

The light source can be of any suitable type . . . . Led for example. One practical consideration in selecting a suitable type of light globe is the fact that the overall height of the unit 1 is may be constrained by the fact that it is fully below the ceiling.

Accordingly, in preferred embodiments it is of a height that will not encroach unduly in a room, or bathroom, of typical height. For this reason, the light globes may be of a type limited in height. For example, the light globes may be light emitting diode (LED) globes, for instance each having a power rating of 10 Watts. There may be an instance where round TR5 32-40 W Fluorescent light tube may be used and fixed onto the unit 1.

The unit 1 further has two heat lamp sockets 18 for accommodating heat lamps 19. According to the preferred embodiment, the heat lamps 19 are in the form of 250 to 375 Watt infra-red light globes.

The heat lamp sockets 18 (contacts 28) also include light globe-type contacts 20 which are adapted to be connected to and controlled by the electronic circuitry 15, these connections being referenced 16 and shown in phantom lines in FIG. 1 as described in more detail below. The unit 1 also includes a fan 21 supported on the fan housing 17, below the mid section housing 2. The unit 1 is adapted for the fan 21 is connected and controlled by the electronic circuitry 15, these connections being referenced 16 and shown in phantom lines in FIG. 1. The unit 1 also includes at least one deodorizer supported placed inside the base housing 27, above the mid section housing 2 and fan housing 17.

The unit 1 has air inlets 22 below the fan 21 to allow the fan to draw air from the room in which is it located. The unit 1 also has louvers 23 above the fan 21 which are configured to direct the air upwards and laterally with respect to the unit, across the surface of the ceiling 3 as indicated by the arrows 24. In many instances a ceiling causes cooling of the steamy air (lowers the dew point) which is thus subject to condensation so that the steam is converted to water which is deposited on the ceiling. This can facilitate the removal of steam from the air.

Also included in the base housing 27 are double sided self adhesive tape strips 25 which allow the base to secure to the ceiling 3 in addition to the batten 5 and batten cap 6 as mentioned above. Such double sided tape can reinforce the connection of the unit 1 to the ceiling 3 and act as a vibration barrier. There is also two boss fittings (33) to allow two screwed fittings to be used to fix the lighting unit to the ceiling. This may be particularly advantageous if the ceiling is of a material which is not sufficiently strong to support the batten 5 together with the full weight of the unit 1 itself.

While only two self adhesive tapes 25 may be required four are shown in FIG. 4, it is to be understood that the number of double sided self adhesive tape may be more (for example 2, 3 or 4 or more), as is suitable for the particular embodiment of the invention the particular circumstances in which the unit 11 according to the embodiment of the invention is intended to be used. The preferred embodiment of the unit 1 is intended as a retro-fit unit in a room such as a bathroom where there is an existing batten-type light fitting on the ceiling 3. Such a light fitting is mounted on a light batten such as the batten 5 and held in place by a batten cap such as the cap 6, typically configured to be screwed onto a threaded end of the batten.

Also attached to the mid section housing 2 there is a plastic strip hinge 11 screwed and glued and on the opposite end is two snap hooks 31 on the lower housing designed to press fit into the mid section housing 2 through two cut outs also in the mid section housing. Note the strip hinge is recessed both into the mid housing 2 and the fan housing 17 to minimize appearance.

To install the unit 1, the existing light fitting can be removed by removing the cap 6 from the batten 5, and installing the unit in its place. This involves passing the batten 5 through the central aperture 4, and tightening the cap 6 in place on the batten, thereby securing the unit to the ceiling 3.

The unit 1 further includes suitable electronic circuitry 15, schematically represented in phantom lines 16. The Electronic circuitry 15 is connected to the electric power connector 12, in particular its electric contacts 13, and to the light sources of 14 and heat lamp sockets 18, and also to the fan 21. These electric connections, referenced 16, are indicated in phantom lines. The commercial version will include a motion detector overriding all functions and is not schematically presented. A hard wired adaptation will also be incorporated into the unit. A two hole terminal block will be placed onto the aperture 4 enabling the existing house wiring to be wired into one side of the terminal block with the disassembled plug lead wired on the opposing side of the terminal block

The Electronic circuitry 15 is configured to control the supply of power from the electric power connector 12 (and hence from the mains power supply 7) to the light sources 14, as well as to the infra-red heating light globes 19 connected to the heat lamp sockets 18, and also to the fan 21, as described further, below.

The electric power connector 12 of the unit 1 can then be plugged into the batten 5. The unit 1 is intended as a combined lighting, heating, and fan unit in a room such as a bathroom where steam is frequently present.

In use, the unit 1 has the light source 14 with cabling, and suitable infrared light globes 19 inserted in the heat lamp sockets 18. The heater globe 19 with its contact 20 when fitted in its sockets 18 is connected to the electric contact 28 of the socket, and also when the light source 14 and the fan 21 is also fitted then it is configured to be connected to the electronic circuit 15 via the electric power connector 12, and via the power supply 7 to which the unit 1 is connected.

As mentioned, the unit 1 is adapted to be fitted to an existing light batten to replace an existing ceiling light. Ceiling lights are typically connected to a single electric switch, and the preferred embodiment of the unit is designed accordingly. However, it will be appreciated that a user may wish to use just the lights 14 for lighting of the room, the infrared light globes 19 for heating the room, the fan 21 for dissipating steam, or combinations of these components.

To address these requirements with the single electric switch 9, the electronic circuitry 15 is adapted for a single switching action, or different combinations of switching actions, controlling these different components or combinations of components of the unit 1. According to the preferred embodiment, the following switching actions on the switch 9 cause the components of the Domestic unit

To be actuated as follows:
1. A single action of closing (on) the switch on 9 causes the light globes 14 and fan 21 to be activated (Page 1 function modes table switching operations 1) and the deodorizer 26 is fan forced with a wick;
2. Then opening (off), closing (on), opening (off), closing (on) again with the switch 9 (i.e. closing it a second time), within a maximum predetermined time period causes the light globes 14, fan 21, and infrared light globes 19 (page 1 function modes table switching operations 2) to be activated and the deodorizer 26 is fan forced with a wick;
3. Then, opening (off), closing (on), opening (off), closing (on), opening (off) and then again closing (on) the switch 9 (i.e. closing it a third time) within a maximum predetermined time period causes only the fan 21 (page 1 function modes table switching operations 3) to be switched on and the deodorizer 26 is fan forced with a wick. According to this embodiment, the fan 21 then remains on for a predetermined period of time (say 5-15 minutes) before it automatically shuts off.

According to the preferred embodiment, the following switching actions on the switch 9 cause the components of the Commercial unit

To be actuated as follows:
1) Summer mode
A single action of closing (on) the switch 9 causes the unit to operate in the summer mode. As you enter the room a motion sensor will detect movement so it will automatically activate the light globes 14 and fan 21 and the deodorizer 26 is fan forced with a wick; (no need to use the switch 9 again as it will stay on all the summer period). The light 14 will stay on for a predetermined time and therefore if the sensor detects no movement then it will switch the lights 14 off and after a predetermined time it will switch the fan 21 off. If there is any movement in the bathroom the lights 14 and fan 21 will stay on until there is no further movement for a predetermined period of time and then it will automatically go through the shutdown sequence again.
2) Winter mode
The opening (off), closing (on), opening (off), closing (on) again with the switch 9 (i.e. closing it a second time), within a maximum predetermined time period causes the unit to operate in the winter mode. As you enter the room a motion sensor will detect movement so it will automatically activate the light globes 14, fan 21, and infrared light globes 19 and the deodorizer 26 is fan forced with a wick; (no need to use the switch 9 again as it will stay on all the winter period). The infrared light globes 19 will stay on for a predetermined time if the sensor detects no movement, then it will switch the infrared light globes 19 off and a after a predetermined time again if the sensor detects no movement it will switch the light globes 14 off and again if the sensor detects no movement after a predetermined time it will switch the fan 21 off in that sequence. If there is any movement in the bathroom the light globes 14, fan 21, and infrared light globes 19 will stay on until there is no further movement for a predetermined period of time and then it will automatically go through the shutdown sequence again.
And/or but not limited to—:
3) There may also be an internal time clock that will be tuned to the summer and winter calendar that will act as an override or sole switching device in regards to the use of the heater globes.
And/or but not limited to—:
4) Internal thermometer that will detect temperature and will activate Heater globes at a preset temperature setting possibly with reference also to the above mentioned internal time/calendar clock.
And/or but not limited to—:
5) Full automatic mode incorporating a motion detector, internal thermometer and a humidity sensor that would gauge the necessity for the heater globes to be activated and possibly a calendar over ride function in the lighting unit therefore eliminating the need for any switching apart from isolating the unit completely.

Note active noise control is always present whilst the fan is on hence power to unit 1.

The above combinations of switching actions can be used depending on the user's requirements. For example, for the domestic unit the first action can be used when a user is showering in a bathroom.

In this case the lights 14 may be needed to illuminate the bathroom, at the same time the fan 21 is required to disperse the steamy air caused by the shower.

The second action may, for example, be used when the user has finished showing and is toweling off. In this case, in addition to the lights 14 and fan 21, the infrared globes 19 (heat lamps) may be required to prevent the user from becoming uncomfortably cold.

The third of the switching actions may be used, for example, where the user leaves the bathroom after toweling dry. Using that switching action causes the fan 21 to remain active for approximately 5-15 minutes thus continuing to circulate and dissipate steam. If the user vacates the bathroom leaving its door open, this allows fresh, drier air to enter the bathroom to assist the fan 21 to diminish the amount of steam in the air and also effectively blow dry the moisture from the ceiling.

For the commercial unit the user may wish to operate the unit depending on the weather especially for the European seasons and therefore initial switching actions will determine what mode the unit will operate in and therefore what components will be operational . . . .

The unit may be equipped with indicators for indicating that the unit is in a mode of operation corresponding to one or more of the above three switching actions. For example, the unit 1 may be provided with a red light emitting diode which flashes when the fan is operating in response to the third switching action.

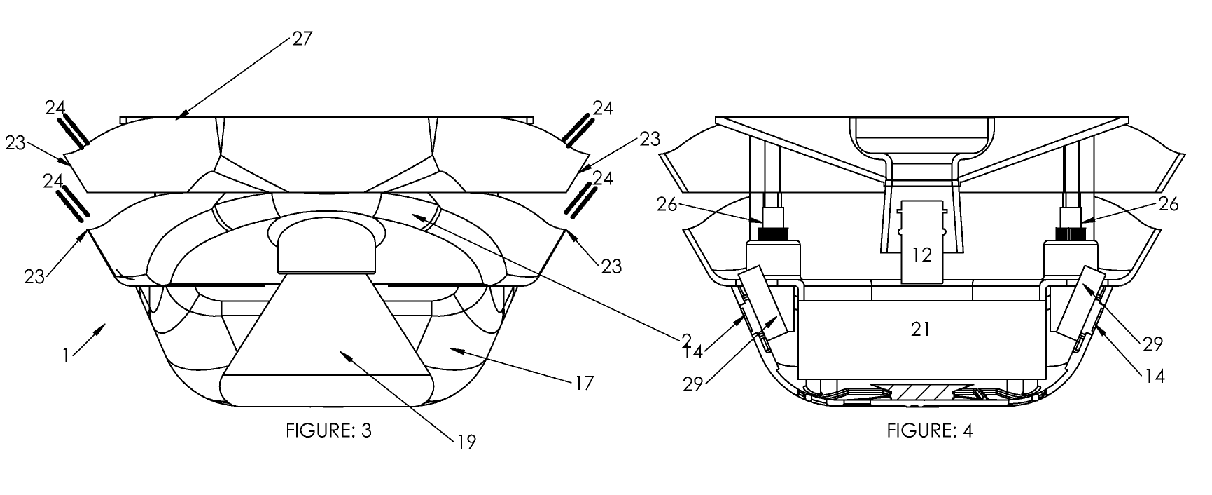

According to a preferred embodiment, the unit 1 also includes a deodorizer 26 a wicked bottle that is placed into at the mid section housing 2 of the unit 1. The deodorizer 26 fragrance is dispersed by the wick which is fan forced as shown in FIGS. 3 & 4. The deodorizer bottles can be replaced when the fragrance has been dissipated by the fan 21 and a new bottled fragrance 26 can be replaced into the unit 1. The deodorizer bottle/wick dispenser 26 can also be made so the wick is heated up dispensing the fragrance even faster into the air.

In a preferred embodiment, the circuitry dispenses deodorizer fragrance in the all switching modes.

Although the invention is described above in relation to preferred embodiments, it will be appreciated by those skilled in the art that it is not limited to those embodiments, but may be embodied in many other forms.

1. A composite lighting unit including:
a base housing adapted to be mounted on a room ceiling; unit mounting means adapted for enabling mounting of the unit to the ceiling; an electric power connector adapted for connection to a power source on the ceiling; at least one light source or a globe on the base housing such that the unit can effect electrical connection between the globe and the electronic circuit via the electric power connector; at least one heater connector supported on the base, adapted for connection to a room heater such that the unit can effect electrical connection between the heater and the electronic circuit via the electric power connector; and at least one fan supported on the unit, wherein the unit is adapted to effect electrical connection between the fan and the electronic circuit via power connector and adapted, when the unit is mounted to a said ceiling, to direct air blown by the fan, from below the fan upwardly and laterally with respect to the unit, across the surface of the ceiling.

2. A composite lighting unit according to claim 1, wherein the unit mounting means includes an aperture in the base, the aperture being adapted for receiving there through a light batten mounted on, and extending from, the ceiling.

3. A composite lighting unit according to claim 2 wherein the unit is adapted for the batten to extend downward through the aperture, and to be at least partly secured to the ceiling by a batten cap fixed to a free end of the batten below the aperture.

4. A composite lighting unit according to claim 2 or claim 3, wherein the light batten constitutes a said power source by being connected to an electric power supply, the electric power connector adapter being adapted for connection to the batten.

5. A composite lighting unit according to any one of the preceding claims wherein the power source forms part of an electronic/electric circuit which is adapted to be opened by a single switch.

6. A composite lighting unit according to claim 5, including circuitry for controlling supply of electric power from the electronic circuit via the power connector to components of the unit being then at least one light source formation, at least one heater connector, and at least one fan, the circuitry being adapted such that different predetermined respective actions in relation to the electronic circuitry cause an electrical connection to be effected between the electric power connector and a predetermined respective one, or combination, of said components, wherein each said action includes a single instance of closing the electronic circuit or a predetermined instance of successive closing and opening of the circuit within a predetermined time period.

7. A composite lighting unit according to any one of the preceding claims including at

8. least one Louvre for directing air forced by the fan upward and laterally with respect to the unit across the surface of the ceiling.

9. A composite lighting unit according to any one of the preceding claims wherein the heater connector includes at least one socket for a heat lamp.

10. A composite lighting unit according to claim 8, including at least one infrared heat lamp in the at least one socket for a heat lamp.

11. A composite lighting unit according to any one of the preceding claims, including a deodorizer device mounted on the base housing, adapted for releasing a deodorizer substance.

12. A composite lighting unit according to claim 6, including an electrically operable deodorizer device with a suitable means of dispersing the fragrance mounted on the base, the deodorizer device being connected to the electronic circuitry, and the circuitry being adapted to cause the deodorizer device to activate the deodorizer substance on the wick allowing for faster dispersion of the fragrance.
